(19) United States
(12) Patent Application Publication
(10) Pub. No.: US 2022/0055252 A1
(43) Pub. Date: Feb. 24, 2022

(54) PREFORM WITH ONE-PIECE WOVEN FIBROUS REINFORCEMENT FOR INTER-BLADE PLATFORM

(71) Applicant: SAFRAN, PARIS (FR)

(72) Inventors: Enrico Giovanni Obert, MOISSY-CRAMAYEL (FR); Dominique Marie Christian Coupe, MOISSY-CRAMAYEL (FR); Marc-Antoine Colot, MOISSY-CRAMAYEL (FR); Fabrice Michel François René Aubert, MOISSY-CRAMAYEL (FR); Pierre Martin Michelsen, MOISSY-CRAMAYEL (FR)

(73) Assignee: SAFRAN, PARIS (FR)

(21) Appl. No.: 17/416,994

(22) PCT Filed: Dec. 20, 2019
(86) PCT No.: PCT/FR2019/053261

§ 371 Date: Jun. 21, 2021

(30) Foreign Application Priority Data
Dec. 21, 2018 (FR) 1873738

(51) Int. Cl. B29B 11/16; B29C 70/48; F01D 11/00

(52) U.S. Cl. CPC B29B 11/16; B29L 2031/082; F01D 11/008; B29C 70/48

(57) ABSTRACT

A preform has a fibrous reinforcement woven in one piece by three-dimensional weaving to create a fan inter-blade platform The platform includes an aerodynamic base and a fixing structure having stiffening elements that extend from the aerodynamic base. The preform includes a first fibrous part configured to form the aerodynamic base, second fibrous part configured to at least partially form the stiffening elements of the inter-blade platform, a first connection zone in which the first and second parts are woven together, and a first disconnection zone delimited by a first disconnection line extending in a transverse direction and in which the first and second parts are separated from one another. The first disconnection zone is adjacent to the first connection zone in a longitudinal direction L.

### TECHNICAL FIELD OF THE INVENTION

The present invention relates to the field of the manufacturing of turbomachine component made of composite material, such as an inter-blade platform for a turbomachine fan.

### BACKGROUND

Prior art comprises documents FR-A1-2 988 427, FR-A1-2 988 426 and WO-A2-2013/088040).

A turbomachine, and in particular a dual flow turbomachine for aircraft, generally comprises a mobile fan arranged upstream of a gas generator according to the flow of gases in the turbomachine. The fan generates a primary flow intended to flow in a primary duct through the gas generator and a secondary flow intended to flow in a secondary duct around the gas generator. The fan comprises movable fan blades which are carried by a rotor disc centred on a longitudinal axis of the turbomachine. Between each fan blade are arranged inter-blade platforms that extend the inlet cone of the fan.

It is known that these platforms are made of a composite material comprising a fibrous reinforcement densified by a matrix so as to reduce their mass and improve their thermomechanical resistance. The composite material platforms comprise an aerodynamic base which allows to constitute a portion of a radially inner wall of an aerodynamic duct of air inlet between two fan blades in order to guide the flow of air entering the turbomachine, and also to ensure its sealing during the operation of the turbomachine by preventing the circulation of the flow of the incoming air towards the inside of the rotor disc. The composite material platforms also comprise a fixing structure so that the inter-blade platforms are integrally mounted in rotation on the rotor disc. The fixing structure comprises an upstream radial flange which is fixed to a flange of an upstream shell and a downstream radial flange fixed to a flange of a downstream drum so as to limit the radial displacement thereof and the aerodynamic performance losses. The fixings are generally made by rods and/or bolts at the level of the flanges. Alternatively, the upstream and downstream flanges are constrained by contact with the upstream shell and the downstream drum respectively.

The inter-blade platforms and in particular the fixing structure are subject to significant stresses, in particular the centrifugal forces during the rotation of the turbomachine, which can lead to the rupture of these attachments and the ejection of the inter-blade platform into the turbomachine and thus generate the destruction of certain parts of the turbomachine. Also, since the platforms are mounted to cover the roots of the fan blades and have a general axial cross-section of frustoconical shape, they increase the hub ratio of the fan between the inlet and the outlet of the fan which can penalize the performance of the turbomachine. The hub ratio is the quotient of the diameter at the radially inner end of the fan blades measured at the leading edge of the fan blade and the diameter at the radially outer end of the blades measured at the leading edge of the blades.

The present invention aims in particular to provide a simple and effective solution allowing to ensure the mechanical strength of a composite material inter-blade platform on a turbine disc under the centrifugal force while improving the performance of the turbomachine.

### SUMMARY OF THE INVENTION

This is achieved in accordance with the invention by a preform with a fibrous reinforcement woven in one piece by a three-dimensional weaving to create a fan inter-blade platform, the inter-blade platform comprising an aerodynamic base extending along a longitudinal axis and a fixing structure comprising stiffening elements which extend from the aerodynamic base along a transverse axis, the preform comprising:
a first fibrous part intended to form the aerodynamic base,
a second fibrous part intended to form at least partly the stiffening elements of the inter-blade platform,
a first connection zone in which the first and second parts are woven together, and
a first disconnection zone delimited by a first disconnection line extending along a transverse direction and in which the first and second parts are separated from each other, the first disconnection zone being adjacent to the first connection zone in a longitudinal direction.

Thus, this solution allows to achieve the above-mentioned objective. In particular, this preform on the one hand, is easy to manufacture in one piece to form a base and stiffeners below the base and on the other hand, allows to answer efficiently to the mechanical strength of the platform on the (fan) rotor disc under the centrifugal force while being light. The disconnections allow to form the stiffening elements which do not occupy a large space below the aerodynamic base but at the same time allow to ensure its function of stiffening and rigid fixing on the rotor disc. This preform also allows to obtain platforms with stiffening elements generally shaped like an I or Y for example, which allow to reduce the hub ratio of the fan, thus improving the performance of the turbomachine. Finally, such a configuration allows to avoid the systematic use of an insert (rigid or in the form of a fibrous preform) called a “gap filler” which is intended to be placed between the first fibrous part forming the aerodynamic base and one of the stiffening elements to fill certain gaps and ensure an acceptable volume ratio of the fibres in the radii.

The preform also comprises one or more of the following characteristics, taken alone or in combination:
the stiffening elements extend from the aerodynamic base along a radial axis and substantially at the level of a median part of the aerodynamic base along the longitudinal axis, the stiffening elements also extending along a transverse axis Y perpendicular to the radial and longitudinal axes,
the preform comprises a second disconnection zone delimited at least by a second disconnection line extending along the transverse direction perpendicular to the longitudinal direction and in which the first and second parts are separated from each other, the second disconnection zone being adjacent to the first connection zone along the longitudinal direction,
the first disconnection zone and the second disconnection zone extend in a same plane,
the first and the second disconnection lines delimit the first connection zone, the second fibrous part being separated along the first and second connection lines so as to form a first structure and a second structure, the first and second structures being intended to form a first and a second arm of the stiffening elements,
the preform comprises a second disconnection zone delimited between a fourth and a fifth disconnection line extending in a same first plane and each along the transverse direction perpendicular to the longitudinal direction and in which the second fibrous part is separated into a first fibrous structure and a second fibrous structure separated from each other along the disconnection zone, the first and second structures being intended to form a first and a second arm of the stiffening elements,
the first disconnection zone extends in a second plane distinct from the first plane, the first and second planes being superimposed along a radial direction perpendicular to the longitudinal direction,
the first fibrous structure and the second fibrous structure are woven together with the first fibrous part in the first connection zone,
the first fibrous structure and the second fibrous structure are woven together in a third connection zone,
the first fibrous part has a length which is greater along the longitudinal direction than that of the first and second fibrous structures,
each first part and second part comprises a plurality of warp threads and weft threads bonded together.
the threads of the fibrous reinforcement comprise carbon fibres, glass fibres, ceramic fibres, Kevlar fibres, polyamide fibres or a mixture of these fibres, and
the first disconnection zone extends between the first edge and the first disconnection line and the first connection zone extends between the second edge and the first connection line.

The invention also relates to a method for manufacturing a composite material fan inter-blade platform, the method comprising the following steps:
weaving a plurality of threads to produce a one-piece preform having any of the foregoing characteristics,
shaping the preform at least by unfolding the second fibrous part with respect to the first disconnection line, and
injecting a matrix into an injection enclosure so as to densify the shaped preform.

The method for manufacturing the preform also comprises one or more of the following characteristics, taken alone or in combination:
the weaving step is made flat,
the first and second parts are woven in the same direction,
the method comprises a step of placing the preform in an injection enclosure of an injection mold,
the method comprises a step of compacting the matrix and the preform,
the method comprises a step of heating the injection mold so as to solidify the matrix,
the method comprises a step of demolding the obtained inter-blade platform,
the method comprises a step of machining the final preform obtained, and
the machining step comprises drilling at least one orifice in a fixing clevis of the platform.

The invention also relates to an inter-blade platform for turbomachine made of composite material comprising a fibrous reinforcement densified by a matrix, the inter-blade platform being made by the method having any one of the above steps and/or characteristics, the platform comprising an aerodynamic base extending along a longitudinal direction and having a radially outer surface intended to form a portion of a radially inner wall of an air inlet aerodynamic duct and a fixing structure configured so as to allow the platform to be fixed to a rotor disc.

Thus, such a platform allows to meet the functional requirements of blade holding and mechanical strength on the fan rotor disc, and to ensure, thanks to a fibrous reinforcement woven in three-dimension, a simplification of the manufacturing with a composite technology (injected 3D woven). This platform also considerably allows to reduce the gap between the inlet of the aerodynamic duct upstream of the inlet cone and the tooth of the rotor disc, which also has a positive effect on the reduction of the ratio hub of the fan and a gain in performance of the turbomachine.

The platform also comprises one or more of the following characteristics, taken alone or in combination:
the stiffening elements have an axial cross-section shaped like a Y,
the stiffening elements and the base of the platform have an axial cross-section shaped like a T,
the stiffening elements and the base of the platform have an axial cross-section shaped like a π,
the fixing structure comprising an upstream radial flange and a downstream radial flange,
the upstream radial flange comprises a collar extending along the longitudinal axis and formed by a pronounced turned-over edge,
the stiffening elements comprise at least one clevis for fixing to a rotor disc of the turbomachine,
the fixing clevis and the fibrous reinforcement extend radially, the fixing clevis being intended to be fixed to the rotor disc so as to extend parallel to the loading direction.

The invention also relates to a turbomachine comprising an inter-blade platform having any of the above characteristics.

### BRIEF DESCRIPTION OF FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is an axial sectional view of a dual flow turbomachine according to the invention;

FIG. 2 shows a perspective view of an example of a platform intended to be installed between at least two adjacent fan blades around a rotor disc according to the invention;

FIG. 3 shows another embodiment of a platform intended to be installed between two adjacent fan blades around a rotor disc according to the invention;

FIG. 4 illustrates an embodiment of a preform with a fibrous reinforcement woven in one piece by a three-dimensional weaving for making an inter-blade platform, the preform comprising a disconnection;

FIG. 5 schematically illustrates a platform of fibrous reinforcement woven according to the example of FIG. 4 and shaped so that a portion of fabric forming stiffening elements extend substantially radially from a part of fabric extending along a general longitudinal direction;

FIG. 6 is a very schematic axial cross-sectional view of an example of injection mold in which the preform shaped according to FIG. 5 is installed and densified;

FIG. 7 illustrates another embodiment of a preform with a fibrous reinforcement woven in one piece by a three-dimensional weaving for making an inter-blade platform, the preform comprising two disconnections;

FIG. 8 schematically illustrates a platform of fibrous reinforcement woven according to the example of FIG. 7 and shaped such that fabric portions forming stiffening elements extend radially from a fabric part extending along a general longitudinal direction; and,

FIG. 9 illustrates another embodiment of a preform with a fibrous reinforcement woven in one piece by a three-dimensional weaving for making an inter-blade platform, the preform comprising two disconnections and being woven flat.

### DETAILED DESCRIPTION OF THE INVENTION

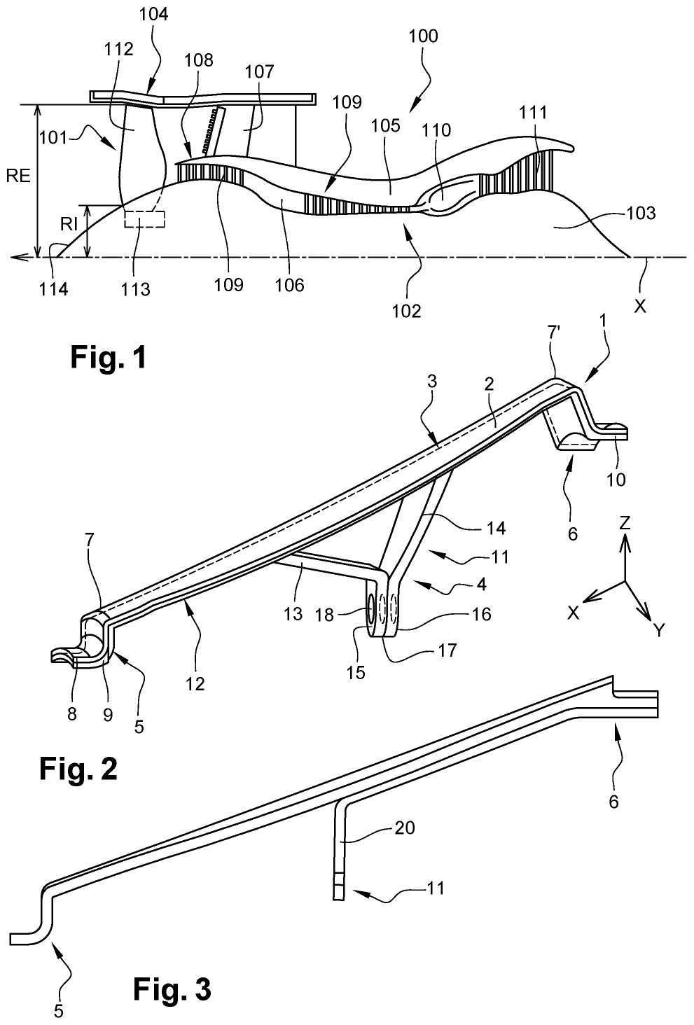

FIG. 1 illustrates an aircraft turbomachine 100 to which the invention applies. This turbomachine 100 is here a dual flow turbomachine that extends along a longitudinal axis X. Of course, the invention can be applied to other types of turbomachine.

The turbomachine 100 comprises a fan 101 arranged upstream of a gas generator 102. In the present invention, and in general, the terms “upstream” and “downstream” are defined in relation to the flow of gases in the turbomachine and here along the longitudinal axis of the turbomachine. The gas generator 102 is housed around an annular inner casing 103 while the fan is housed in an annular outer casing 104. These inner and outer casings 103, 104 are separated by an annular inter-duct casing 105 so as to delimit a primary duct 106 and a secondary duct 107. The inter-duct casing 105 carries an annular flow-splitting nose 108 separating the primary duct from the secondary duct.

The fan 101 generates a primary flow intended to flow in the primary duct 106 through the gas generator and a secondary flow to flow in the secondary duct 107 around the gas generator.

The gas generator 102 comprises from upstream to downstream a compressor assembly 109, a combustion chamber 110, and a turbine assembly 111. In general, the fan 101 comprises fan blades 112 each with a free end facing the outer casing 104 so as, on the one hand, to ensure a first compression of the flow of air incident in the turbomachine which is directed towards the primary duct and, on the other hand, to drive the flow of air which passes into the secondary duct in order to provide a non-negligible component of the thrust. The primary flow flowing through the primary duct is typically compressed by a stage or stages of the compressor assembly before entering the combustion chamber. The combustion energy is recovered by one or more stages of the turbine assembly that participate in driving the stages of the compressor and the fan.

The fan module comprises fan blades 112 extending radially from a rotor disc 113 (shown schematically) integral with a fan shaft which passes through it and which is centred on the longitudinal axis X. The terms “inner”, “outer”, “radial” and “radially” are defined with respect to a radial axis Z which is perpendicular to the longitudinal axis X of the turbomachine. The fan shaft is rotated by a low pressure shaft via a power transmission mechanism not shown. The disc 113 comprises a plurality of grooves that are evenly distributed around the periphery of the disc and extend substantially along the longitudinal axis. The fan blade roots are each located in a groove. The latter has a profile complementary to that of the blade root (e.g. shaped like a fir tree). The grooves form teeth between them which extend substantially along the longitudinal axis and advantageously along the rotor disc. In other words, a tooth is delimited and formed by two circumferentially adjacent grooves.

With reference to FIG. 2, the fan module is also equipped with a plurality of inter-blade platforms 1 which are each arranged, at least, between two adjacent fan blades 112 at the level of the rotor disc 113 and to which we are particularly interested. Each inter-blade platform 1 comprises an aerodynamic base 2 extending along the longitudinal axis (in a situation where the platform is installed in the turbomachine). In the following, we will assume that the platform 1 is mounted in the fan module. The aerodynamic base 2 comprises a radially outer surface 3 intended to form a portion of a radially inner wall of an aerodynamic inlet duct. The inlet airflow is guided between the fan blades 112 in the aerodynamic inlet duct. The latter is extended downstream by the primary duct 106 of the turbomachine. Each inter-blade platform 1 further comprises a fixing structure 4 allowing to fix it to the rotor disc 113. This fixing structure 4 extends at least partly radially below the aerodynamic base 2 and also allows, on the one hand, to stiffen the aerodynamic base 2 and, on the other hand, to distribute the centrifugal forces over several elements so as to reduce the stresses and ensure the mechanical strength. In the following description, only one platform is described, it is understood that all inter-blade platforms have the same configuration.

The fixing structure 4 comprises an upstream radial flange 5 and a downstream radial flange 6 which are located respectively at a longitudinal end 7, 7′ of the aerodynamic base 2. The upstream and downstream radial flanges 5, 6 are opposite each other along the longitudinal axis X. The upstream radial flange 5 allows a fixing to an upstream flange of an upstream shell (not shown) which is fixed to the rotor disc. The upstream radial flange 5 comprises a collar 8 which extends substantially along the longitudinal axis (towards upstream) from the end 9 of the radial flange 5. The collar 8 is advantageously formed by a very pronounced turned-over edge. In particular, the upstream radial flange 5 is intended to be supported against and radially along a radial wall of the tooth of the disc. The collar 8 is intended to come to bear against a shoulder of the upstream shell so as to ensure a radial retention of the inter-blade platform 1. In particular, the collar 8 comes below the shoulder of the upstream shell. The latter is at least partly enveloped by an inlet cone 114 (see FIG. 1) of the fan which guides the incoming airflow to the blades of the fan 112. The radially outer surface of the platform 3 has a surface continuity with the outer surface of the inlet cone.

The downstream radial flange 6 allows a fixing to a downstream flange of a drum (not shown) which is fixed on the rotor disc. The downstream radial flange 6 also comprises a collar 10 which extends along the longitudinal axis (towards downstream) from the end of the downstream radial flange 6. The collar 10 is also advantageously formed by a turned-over edge which comes to bear below the downstream flange of the drum to ensure a radial retention of the inter-blade platform.

The two radial upstream and downstream flanges 5, 6 then constitute two support points for the inter-blade platform 1, which, when subjected to centrifugal force, is held in place radially by the contact with the upstream shell and the downstream drum.

As can also be seen in FIG. 2, the fixing structure 4 is completed by stiffening elements 11 which extend substantially radially from a radially inner surface 12 of the inter-blade platform 1. The radially inner surface 12 is opposite the radially outer surface 3 along the radial axis. The stiffening elements 11 are arranged at the level of a median part of the inter-blade platform. These stiffening elements 11 extend along a transverse axis Y. This transverse axis is perpendicular to the longitudinal and radial axes as shown in FIG. 2. The stiffening elements 11 allow to stiffen the aerodynamic base 2 without occupying at least the space below the upstream part of the inter-blade platform.

The stiffening elements 11 and the inter-blade platform 1 (with the base 2 and the radial flanges 5, 6) are formed in one piece.

Such a configuration of the fixing structure 4 (in particular the fact that it is substantially in the middle of the base 2 axially) allows to reduce the hub ratio RE (illustrated in FIG. 1). Indeed, the collar 8 has a thickness (here along the radial axis as shown in FIG. 2) which is reduced. The forces it has to withstand are lower than with a conventional box-type fixing structure (upstream and downstream radial flanges). This type of conventional fixing structure takes up space under the collar and/or involves increasing the radial thickness of the collar. In the present invention, the terms “axial” and “axially” are defined with respect to the longitudinal axis X.

In the example shown in FIG. 2, the stiffening elements 11 have an axial cross-section or a general shape substantially shaped like a Y. In particular, the stiffening elements 11 comprise a first arm 13 connected to the base 2. The stiffening elements 11 further comprise a second arm 14 connected to the base 2. The first arm 13 comprises a first radial leg 15 which is fixed to a second leg 16 of the second arm 14. The first and second legs form a clevis 17 for fixing to the rotor disc. The fixing clevis 17 extends radially. The first and second arms 13, 14 form the two branches of the Y and each a point of contact with the aerodynamic base 2. The first and second legs 15, 16 form the root of the Y. The first and second arms 13, 14 allow to transfer the centrifugal forces to the fixing clevis 17 fixed to the rotor disc. The fixing clevis 17 comprises an orifice 18 passing through the wall on both sides along the longitudinal axis. Fixing elements such as a pin or a stud are received through the orifice to fix the inter-blade platform to the rotor disc 113.

In another embodiment shown in FIG. 3, the stiffening elements 11 extend substantially radially from the aerodynamic base 2. In this example of embodiment, the aerodynamic base 2 and the stiffening elements 11 have an axial cross-section or a general shape substantially shaped like a T. In other words, the stiffening elements 11 comprise a single arm 20 that extends radially from the aerodynamic base 2 of the inter-blade platform.

In yet another embodiment not shown, the stiffening elements 11 extend radially from the aerodynamic base 2. In this example, the stiffening elements 11 and the aerodynamic base 2 have an axial cross-section or a general shape substantially shaped like a π (Pi). In particular, the stiffening elements 11 comprise a first and a second arm extending radially from the base (as in the embodiment of FIG. 2). These are spaced apart from each other, however. There is no joint at the free end of each first and second arm. In this case, each free end of the first and second arms comprises a through orifice for receiving fixing elements.

In these embodiments, the inter-blade platform 1 is made of a composite material with a fibrous reinforcement embedded in a matrix. In particular, the platform 1 is obtained by manufacturing a preform 30 made in a three-dimensional weaving (or 3D weaving) of threads to obtain the fibrous reinforcement. In the present invention, the term “three-dimensional weaving” or “3D weaving” is understood to mean a weaving method in which warp threads are bonded to weft threads in several layers.

In particular, the method for manufacturing a turbomachine component such as a turbomachine inter-blade platform comprises the following steps:
weaving a plurality of threads for making a preform with a three-dimensional fibrous reinforcement,
optional cutting of the edges of the fibrous reinforcement so that the contour of the preform is as close as possible to that of the inter-blade platform,
wetting in which the fibrous reinforcement of the preform is moistened, for example with water, so that it is easier to handle and in particular to change the orientation of the warp threads with respect to the weft thread (shifting),
shaping the preform in which an operator moves the threads so as to shape the fibrous reinforcement to the desired profile of the platform,
drying the preform in which the water used for wetting is extracted from it. The preform stiffens after drying and held the shape made by the operator. This step can be made by heating the fibrous reinforcement in a suitable enclosure.
injecting a matrix according to the RTM (Resin Transfer Moulding) technology in order to densify the preform and obtain the desired inter-blade platform. The matrix allowing a densification of the fibrous reinforcement may be a polymeric matrix such as an epoxy-based thermosetting resin. The polymeric matrix may also be a thermoplastic resin. We obtain a rigid component after a hardening or polymerization of the matrix.
If necessary, the platform obtained is machined at the end of the method.

More specifically, we are interested in the steps of three-dimensional weaving of the preform 30 in one piece and shaping it. The weaving of the preform is made by means of a loom configured for three-dimensional weaving. The weaving is advantageously made flat and the obtained preform also has a generally flat shape with varying thicknesses. The threads used comprise carbon, Kevlar, polyamide, ceramic, alumina fibres or a mixture of these fibres. Advantageously, the warp and weft threads comprise carbon fibres. To facilitate the subsequent shaping of the preform (apart from the wetting step which allows the threads to be moved between them), the preform 30 comprises several fibrous parts which comprise connection zones and disconnection zones which are made during the weaving. The parts of the preform 30 each comprise a plurality of layers of threads or fibrous layers woven between them.

In this description, the term “disconnections” is used to refer to zones that are intentionally formed by layers of threads that are not locally bonded or woven together. In particular, the disconnections allows layers or fibrous parts to be unfolded or separated from other adjacent layers or fibrous parts at the level of the disconnection zones.

In the present example of embodiment, the warp threads of the preform 30 have a direction substantially parallel to the longitudinal axis (along the length of the aerodynamic base) and the weft threads have a direction substantially parallel to the transverse axis. Alternatively, the direction of the weft threads is parallel to the transverse axis and the direction of the weft threads is parallel to the longitudinal axis. Of course, the directions of the warp threads are perpendicular to the directions of the weft threads.

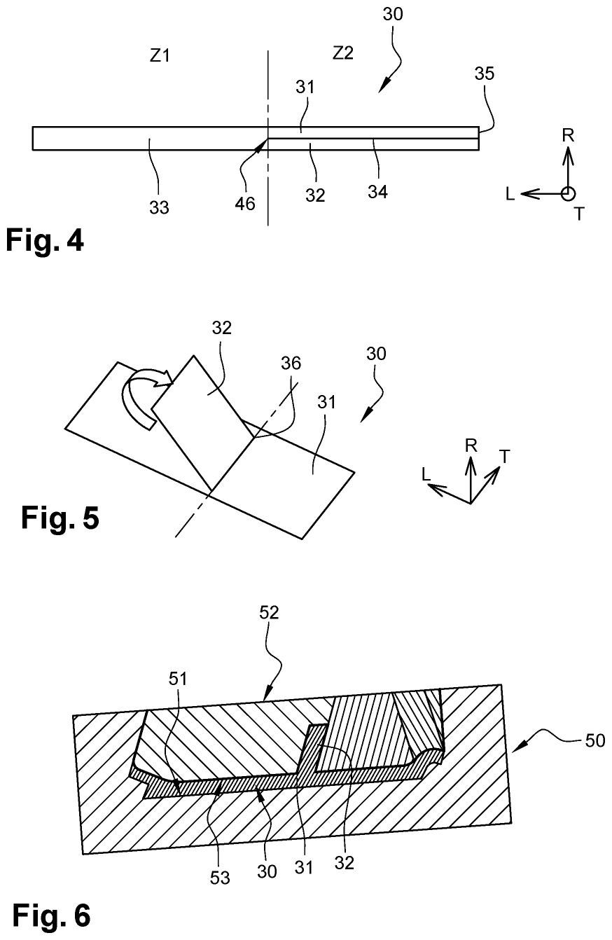

FIGS. 4 to 9 show schematically preforms with fibrous reinforcements woven in one piece allowing to obtain different inter-blade platforms as described above. The preform 30 has a general parallelepiped shape (here rectangular parallelepiped). In the description of the preform, we use the terms longitudinal direction, radial direction and transverse direction to define its dimensions.

With reference to FIG. 4, the preform 30 comprises a first fibrous part 31 and a second fibrous part 32 allowing to obtain an inter-blade platform 1 and stiffening elements 11 with the axial cross-section shaped like a T as illustrated in FIG. 3. The first and the second fibrous parts 31, 32 are woven flat. The first fibrous part 31 is intended to form the aerodynamic base 2 of the inter-blade platform 1 while the second fibrous part 32 is intended to form the stiffening elements 11. The first part and the second part 31, 32 extend along the longitudinal direction L in FIG. 4. All the upper layers (with respect to the radial direction R perpendicular to the longitudinal direction) of the first part 31 are continuous so as to guarantee a good mechanical strength and a continuity of stiffness on the radially outer surface of the obtained inter-blade platform.

The first and second parts 31, 32 are woven to form at least one connection zone 33 and at least one disconnection zone 34. The first fibrous part 31 and the second fibrous part 32 are woven together or bonded to each other on a first zone Z1 of the preform. The first zone Z1 thus comprises only one fibrous layer. Similarly, the first and second fibrous parts are disconnected in a second zone Z2 of the preform 30. In particular, the first and the second part 31, 32 are separated from each other by a disconnection that extends along the transverse direction of the preform 30. The formed disconnection zone 34 extends between a first edge 35 and a disconnection line 46 along the longitudinal direction of the preform. On the other hand, the disconnection zone 34 extends between a first side and a second side opposite each other along the transverse direction. The second zone comprises here two fibrous layers which are superimposed along the radial direction. In the present example, the disconnection line 46 is located in the middle of the length of the preform along the longitudinal direction. Of course, this disconnection line 46 could be located at a different distance, such as one-third or two-thirds of the first edge 35.

In FIG. 5, a portion of the second part 32 of the preform 30 is spread or unfolded from the first part 31 of the preform during the shaping thereof. The second part 32 is opened or unfolded from the first edge 35. It can be seen that the second part 32 is completely separated from the first part at the level of the disconnection line 46 extending along the transverse direction. On the other hand, the second part 32 and the first part 31 are completely woven together over a whole first portion of the preform (first zone Z1). The second part 32 when unfolded forms the only arm 20 of the stiffening elements 11. The preform 30 follows the rest of the manufacturing method until the matrix is injected into an injection mold 50 such as the one shown in FIG. 6.

With reference to FIG. 6, the mold 50 has a first inner cavity 51 intended to receive the preform 30 that has been shaped in the shaping step. The shaping step is advantageously made in the mold on the first cavity 51 which has a shape corresponding to that desired for the final platform. The mold 51 is previously closed by a counter-mold 52 comprising a second cavity 53. The first and second cavities form an injection space into which a matrix is injected. The matrix is chosen according to the desired application, here for the inter-blade platform. The matrix impregnates the fibrous reinforcement of the preform with the second fibrous part forming the arm of the stiffening elements in an injection mold. The first fibrous part is also shaped to form the upstream and downstream flanges of the aerodynamic base before injection of the matrix.

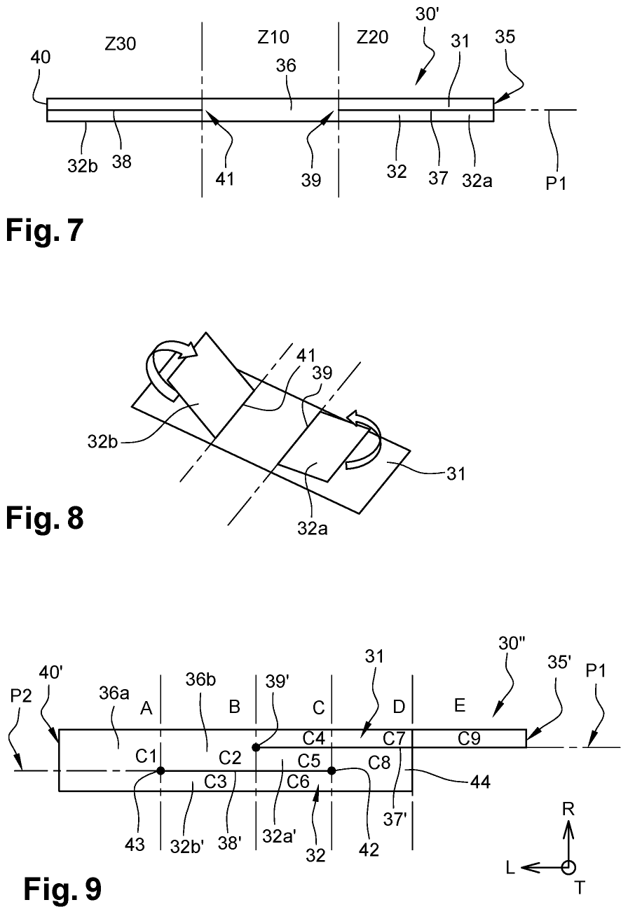

FIG. 7 illustrates another embodiment of a preform 30′ intended to make an inter-blade platform 1 and stiffening elements 11 whose axial cross-section is substantially shaped like a π(pi). FIG. 7 shows the preform 30′ woven flat with the first and second parts 31, 32 extending along the longitudinal direction. The first fibrous part is intended to form the aerodynamic base of the inter-blade platform while the second fibrous part is intended to form the stiffening elements. This preform 30′ differs from the preform 30 described in relation to FIGS. 4 to 6 in that it comprises two disconnections between the first and the second fibrous parts. The disconnections allow to separate the first fibrous part from the second fibrous part on both sides of a connection zone 36 along the longitudinal direction. Here, the connection zone 36 is located in an intermediate zone Z10 of the preform 30′. Two disconnection zones 37, 38 extend respectively in a first zone Z20 and a second zone Z30 of the preform 30′. In particular, the first disconnection zone 37 extends between the first edge 35 and a first disconnection line 39 along the longitudinal direction L. The first disconnection zone 37 further extends between the first side and the second opposite side of the preform along the transverse direction. The second disconnection zone 38 extends between a second edge 40 and a second disconnection line 41. On the other hand, the second disconnection zone 38 extends between the first side and a second opposite side along the transverse direction. The connection zone 36 is arranged axially between the two disconnection zones 37, 38. In particular, the disconnection zone 36 is axially delimited by the first and second disconnection lines 39, 41. In this example, the two disconnection zones extend in a same plane P1 which is perpendicular to the radial direction.

The length of the first and second zones Z20 and Z30 along the longitudinal direction is identical. Of course, another configuration of these zones Z20 and Z30 is possible

Furthermore, in the first zone Z20, two fibrous layers are superimposed along the radial direction. The second zone Z30 also comprises two fibrous layers superimposed along the radial direction. Finally, the intermediate zone Z10 comprises only one fibrous layer. The zones Z30, Z10 and Z20 are adjacent to each other along the longitudinal direction L.

When separating or unfolding the preform 30′ as shown in FIG. 8, we obtain a first structure 32a of the second fibrous part completely separated from the first part at the level of the first disconnection line 39 so as to form the first arm of the stiffening elements of the preform. A second structure 32b of the second fibrous part 32 is also completely separated from the first fibrous portion at the level of the second disconnection line 41 so as to form the second arm of the stiffening elements 11. The shaped preform 30′ is densified by injecting the matrix into the mold adapted to the shape of the preform. During shaping, the first fibrous part is also shaped to form the upstream and downstream flanges of the aerodynamic base.

In this example of embodiment, the first and second structures 32a, 32b of the second fibrous portion 32 are woven in the same direction. The direction may be from upstream to downstream or from downstream to upstream along the longitudinal direction of the preform 30′. Alternatively, the first and second structures 32a, 32b are woven in opposite directions. In this case, the first structure 32a may be woven downstream from the first disconnection line 39 while the second structure 32b may be woven upstream from the second disconnection line 41.

FIG. 9 illustrates very schematically a preform 30″ intended to make an inter-blade platform and stiffening elements, the stiffening elements having an axial cross-section substantially shaped like a Y as illustrated in FIG. 2. The preform 30″ is made in substantially the same manner as the preform 30′ shown in FIGS. 7 and 8. That is to say, the preform 30″ in the present example comprises two disconnections which allow the second fibrous part 32 to be separated from the first fibrous part 31 and to form at the same time the first fibrous structure 32a and the second fibrous structure 32b. The first and second structures 32a, 32b are intended to form respectively a first arm 13 and a second arm 14 of the stiffening elements 11 of the inter-blade platform.

However, this preform 30″ differs from the preform in FIGS. 30′ in that the first and second structures 32a, 32b are joined together at their ends so as to form the fixing clevis 17 on the rotor disc of the fan 101. The junction between the first and second structures 32a, 32b is obtained by a joint weaving during the three-dimensional weaving step or a densification during the injection of the matrix into the injection mold (co-injection). The weaving of the first and second structures 32a, 32b together allows to improve the interlaminar shear strength that results from the stress that will be exerted on the clevis in operation. This improves the mechanical properties and the durability of the component.

In this example of embodiment, the connection of the two fibrous structures 32a, 32b is made by a weaving during the weaving step. Thus, the preform 30″ comprises a first disconnection zone 37′ which extends between the first edge 35′ of the preform 30″ and a first disconnection line 39′ along the longitudinal direction L. The first disconnection zone 37′ further extends between the first side and the second opposite side of the preform 30′ along the transverse direction. The first part 31 intended to form the base of the platform separates from the second part intended to form the stiffening elements 11 forming a Y, following a disconnection.

A second disconnection zone 38′ is delimited between a fourth disconnection line 42 and a fifth disconnection line 43. The fourth and fifth disconnection lines 42, 43 extend in a same plane P2 and each along a transverse direction perpendicular to the longitudinal direction. In this disconnection zone, the second fibrous part 32 is separated into the first fibrous structure 32a′ and the second fibrous structure 32b′ by a disconnection.

The first and the second disconnection zone 37′ extend in distinct and parallel planes P1, P2. The planes P1, P2 are superimposed along the radial direction R. Also, parts of the first and second disconnection zones 37′, 38′ are superimposed along the radial direction.

The preform 30″ comprises a connection zone 36a where the first and second parts (first and second fibrous structures) are woven together. This first connection zone 36a extends between the second edge 40′ and the fifth disconnection line 43. A second connection zone 36b extends between the second edge 40′ and the first disconnection line 39′. A third connection zone 44 (corresponding to the weaving of the first and second structures to form the fixing clevis 17) extends longitudinally between the fourth disconnection line 42 and the first edge 35′ of the preform.

As illustrated, the first fibrous part 31 has a greater length than that of the second structure 32 (first and second structures 32a′, 32b). In this way, the first fibrous part extends longitudinally beyond the third connection zone 44. This length will allow the upstream radial flange to be formed during the shaping of the platform.

In order to achieve this weaving to bond the first and second structures 32a′, 32b′, the fibrous reinforcement is woven flat along a general longitudinal direction. The first and second structures 32a, 32b intended to form the arms of the stiffening elements 11, as well as the first fibrous part intended to form the base 2 are woven in the same direction. Advantageously, the weaving direction is parallel to the warp threads and from upstream to downstream according to FIG. 9. Alternatively, the weaving is made with weft threads and from upstream to downstream.

Considering FIG. 9, the preform 30″ comprises several adjacent and successive zones along the general longitudinal direction and from upstream to downstream. Here, there are five successive zones along the longitudinal direction referred to as A, B, C, D and E. In particular, the first zone A comprises a first fibrous layer C1 (a single fibrous layer) intended to form at least partly the aerodynamic base and the second zone B comprises two fibrous layers, namely a second fibrous layer C2 and a third fibrous layer C3. These second and third fibrous layers C2, C3 are separated by a disconnection (part of the disconnection zone 38). In this way, the second layers and the third layers are superimposed along the radial direction. The second layer is intended to form at least a part of the aerodynamic base of the inter-blade platform. The third layer partly forms the stiffening elements 11.

The third zone C comprises three fibrous layers, namely a fourth fibrous layer C4, a fifth fibrous layer C5 and a sixth fibrous layer C6. The fourth, fifth and sixth layers are separated by two disconnections. These are parts of the disconnection zones 37′, 38′. The latter extend in distinct and parallel planes. The fourth fibrous layer C4 forms at least partly the aerodynamic base. The fifth and sixth layers C5, C6 form at least partly the stiffening elements 11.

The fourth zone D comprises two fibrous layers, namely a seventh fibrous layer C7 and an eighth fibrous layer C8 superimposed along the radial direction. A single disconnection therefore separates these two layers. This is a portion of the disconnection zone 37′. The seventh layer C7 is intended to form at least partly the aerodynamic base 2 and the eighth layer C8 forms at least partly the stiffening elements. This eighth layer of 3D woven is intended to form the connection at the end of the first and second arms forming the stiffening elements 11.

Finally, the fifth zone E comprises a single layer. This is a ninth fibrous layer which extends along the general longitudinal direction and is intended to form at least partly the aerodynamic base.

Thus, the preform is woven from the zone A to the zone E by making disconnection zones to separate layers between them.

During the separation or unfolding of the preform 30″, we obtain a separation of the first part and the second part at the level of the first disconnection zone 37′ in order to form the base 2 and the stiffening elements 11. The second part is separated along the second disconnection zone 38′ to form the first and second structures 32a′, 32b′ intended to form the first and second arms while having a weaving at their ends to form the fixing clevis 17. The shaped preform 30″ is densified by injecting the matrix into the mold adapted to the shape of the preform. During shaping, the first fibrous part is also shaped to form the upstream and downstream flanges of the aerodynamic base. The fixing clevis 17 and the arrangement of the fibrous reinforcement in this fixing clevis are parallel to the loading direction, i.e. in the radial direction, which allows for a better mechanical strength compared to the fixing elements of the prior art which generally extend along a direction perpendicular to the loading direction.

When the rigid components have been obtained after densification of the matrix, at least one hole is drilled to form the orifice 18 of the fixing clevis 17 of the inter-blade platform. Advantageously, an annular metal insert (not shown) is installed in the orifice of the clevis. The metal insert is mounted by crimping. Such a metal insert allows to reduce wear of the composite material at the level of the wall of the orifice. The service life of the platform is then guaranteed.

The first fibrous part 31 intended to form the aerodynamic base of the platform may be woven in a two-dimensional 2D weaving or a three-dimensional weaving.

1. A preform with a fibrous reinforcement woven in one piece by a three-dimensional weaving to create a fan inter-blade platform, the inter-blade platform comprising an aerodynamic base extending along a longitudinal axis and a fixing structure comprising stiffening elements which extend from the aerodynamic base along a radial axis and substantially at the level of a median part of the aerodynamic base along the longitudinal axis, the stiffening elements also extending along a transverse axis Y perpendicular to the radial and longitudinal axes, the preform comprising:
a first fibrous part intended to form the aerodynamic base (2) and extending along a longitudinal direction L;
a second fibrous part intended to form at least partly the stiffening elements of the inter-blade platform;
a first connection zone in which the first and second parts are woven together; and
a first disconnection zone delimited by a first disconnection line extending along a transverse direction T perpendicular to the longitudinal direction and in which the first and second parts are separated from one another at least from the first disconnection line so as to obtain stiffening elements having an axial cross-section with respect to the longitudinal axis shaped like a T, Y, or π with the aerodynamic base, the first disconnection zone being adjacent to the first connection zone in a longitudinal direction L.

2. The preform according to claim 2, further comprising a second disconnection zone delimited at least by a second disconnection line extending along the transverse direction and in which the first and second parts are separated from each other, the second disconnection zone being adjacent to the first connection zone along the longitudinal direction L.

3. The preform according to claim 2, wherein the first disconnection zone and the second disconnection zone extend in a same plane (P1).

4. The preform according to claim 2, wherein the first and the second disconnection line delimit the first connection zone, the second fibrous part being separated along the first and second connection lines to form a first structure and a second structure, the first and second structures being configured to form a first and a second arm of the stiffening elements.

5. The preform according to claim 1, further comprising a second disconnection zone delimited between a fourth and a fifth disconnection line extending along the same first plane (P2) and each along the transverse direction and in which the second fibrous part is separated into a first fibrous structure and a second fibrous structure separated from each other along the disconnection zone, the first and second structures being configured to form a first arm and a second arm of the stiffening elements.

6. The preform according to claim 5, wherein the first disconnection zone extends in a second plane distinct from the first plane, the first and second planes being superimposed along a radial direction perpendicular to the longitudinal direction.

7. The preform according to claim 5, wherein the first fibrous structure and the second fibrous structure are woven together with the first fibrous part in the first connection zone.

8. The preform according to claim 5, wherein the first fibrous structure and the second fibrous structure are woven together in a third connection zone.

9. The preform according to claim 5, wherein the first fibrous part has a length that is greater along the longitudinal direction than that of the first and second fibrous structures.

10. A method for manufacturing a composite material fan inter-blade platform, the method comprising the following steps:
weaving a plurality of threads to produce a one-piece preform according to claim 1;
shaping the preform at least by unfolding the second fibrous part with respect to the first disconnection line; and
injecting a matrix into an injection enclosure to densify the shaped preform.

11. The method according to claim 10, wherein the weaving step is made flat.

12. The method according to claim 10, wherein the first and second parts are woven in the same direction.

13. An inter-blade platform for a turbomachine made of a composite material comprising a fibrous reinforcement densified by a matrix, the inter-blade platform being produced by the method according to claim 12, the platform comprising an aerodynamic base extending along a longitudinal axis and having a radially outer surface configured to form a portion of a radially inner wall of an air inlet aerodynamic duct, and a fixing structure configured to allow the platform to be fixed to a rotor disc.

14. The inter-blade platform according to claim 13, wherein the stiffening elements have an axial cross-section shaped like a Y.

15. The inter-blade platform according to claim 13, wherein the stiffening elements and the base of the platform have an axial cross-section shaped like a T.

16. The inter-blade platform according to claim 13, wherein the stiffeners and the base of the platform have an axial cross-section shaped like a π.
